(19) United States
(12) Patent Application Publication
(10) Pub. No.: US 2025/0227221 A1
(43) Pub. Date: Jul. 10, 2025

(54) SYSTEM AND METHOD FOR MEASURING DEPTH OF FIELD FOR A CAMERA

(71) Applicant: E-CON SYSTEMS INDIA PRIVATE LIMITED, CHENNAI (IN)

(72) Inventor: MAHESHWARI DHAYANANDAN, CHENNAI (IN)

(21) Appl. No.: 18/403,828

(22) Filed: Jan. 4, 2024

(51) Int. Cl. H04N 17/00; G06T 7/00; G06T 7/80

(52) U.S. Cl. CPC H04N 17/002; G06T 7/0004; G06T 7/80; G06T 2207/30168

(57) ABSTRACT

A system for measuring depth of field for a camera is disclosed. The system includes a housing, an image sharpness measurement module, a lens parameter measurement module, and a processing subsystem. The housing includes a collimators arrangement arranged at different focus distances and a camera beneath collimators arrangement in order to capture the images projected by the collimators arrangement. The lens parameter measurement measures a plurality of lens parameters. The automation processing module receives a file including a plurality of first parameters and a plurality of second parameters, receives and reads a camera product code as an input from a user, loads a plurality of optical parameters from the file, records one or more measured values from the camera by the collimator, compares the recorded values with a corresponding predefined values from the file, and automatically decide the acceptance and non-acceptance of the camera product code.

### FIELD OF INVENTION

Embodiments of a present disclosure relate to a technical field of distance calculation and more particularly to a system and a method for measuring depth of field for a camera.

### BACKGROUND

The depth of field (DOF) is the distance between the nearest and the furthest objects that are in acceptably sharp focus in an image captured with a camera. In camera production, the depth of field is an important parameter which determines a range of distances in which objects appear sharp and in focus. Depth of field may be affected by several factors such as aperture, focal length of a lens used in the camera, and the distance to an object. Also, accurate measurement of depth of field is crucial for ensuring consistent image quality across different cameras and lenses.

Traditionally, measuring depth of field has been a manual and time-consuming process. It requires skilled technicians to carefully adjust the camera settings and take multiple test shots to determine the optimal focus point. This approach is not only slow and laborious, but it also introduces a risk of human error and inconsistency. A problem in measuring depth of field with existing systems and methods is different cameras have different sensor sizes, which may affect the depth of field which may affect accuracy of measurement. The measurements done by existing systems and methods do not take into account the effects of diffraction, which can significantly affect the sharpness of an image.

Hence, there is a need for a system and a method for measuring depth of field for a camera which addresses the aforementioned issues.

### OBJECTIVE OF THE INVENTION

An objective of the present invention is to provide a system for accurately calculating depth of field for a camera.

Another objective of the present invention is to measure the depth of field automatically.

Yet, an object of the present invention is to provide a collimator set up ensuring the camera lenses to meet the desired performance specifications before being released to the market, thereby providing customers with high-quality imaging products.

Further, an objective of the present invention is to ensure that the camera parameters are checked and configured to suit the field application during the production of the cameras. The lenses used in the cameras have different optical parameters, so the process of qualifying the lens is to check the sharpness at minimum and maximum distance suitable for the application.

### BRIEF DESCRIPTION

In accordance with another embodiment, a system for measuring depth of field for a camera is provided. The system includes a housing, an image sharpness measurement module, lens parameter module, and a processing subsystem. The housing includes a collimators arrangement and a camera for which the depth of field is to be measured. The camera is positioned beneath the collimators arrangement in order to capture the images projected by the collimators arrangement. The collimators arrangement is fixed, and configured such that simulating the images are of a minimum focus length and a maximum focus length. The camera is adapted to check image sharpness using a modulation transfer function. The camera is focused from minimum to maximum if the modulation transfer function is within a predefined focus range. The image sharpness measurement module is adapted to measure sharpness of the target image. The lens parameter measurement module configured to measure a plurality of lens parameters. The processing subsystem hosted on a server, configured to execute over a network to control a bidirectional flow among the housing, the image sharpness measurement module, the lens parameter measurement module, and an automation processing module. The automation processing module receives a file. The file includes a plurality of first parameters used in the automation processing module to automatically measure the depth of field. The file also includes a plurality of second parameters. The plurality of second parameters includes a camera product code, number of collimators, minimum and maximum object distance, minimum and maximum modulation transfer function used by the automation processing module to automatically measure the depth of field. The automation processing module is configured to receive a camera product code as an input from a user. The automation processing module is also configured to read the file relevant to the camera product code and select a predefined number of collimators. Further, the automation processing module is configured to load a plurality of optical parameters from the file and initiate a test process. The test process is performed to determine a qualification of the depth of focus of the camera. Furthermore, the automation processing module is configured to record one or more measured values from the image captured by the camera. Furthermore, the automation processing module is configured to compare the recorded values with a plurality of corresponding predefined values from the file. Furthermore, the automation processing module is configured to automatically decide the acceptance and non-acceptance of the camera product code based on the comparison of the recorded one or more measured values with the predefined values from the file.

In accordance with one embodiment of the disclosure a method for measuring depth of field for a camera is provided. The method includes arranging, a collimators arrangement which is fixed and configured such that simulating the images are of a minimum focus length and a maximum focus length. The method also includes positioning, a camera beneath collimators arrangement in order to capture the images projected by the collimators arrangement. The camera is adapted to check image sharpness using a modulation transfer function. Further, the method includes focusing, the camera from minimum to maximum if the modulation transfer function is within a predefined focus range. Furthermore, the method includes measuring, by an image sharpness measurement module, sharpness of the target image. Furthermore, the method includes measuring, by a lens parameter measurement module, a plurality of lens parameters. Furthermore, the method includes automatically measuring, by a plurality of first parameters of an automation processing module, the depth of field. Furthermore, the method includes automatically measuring, by a plurality of first parameters of the automation processing module, the depth of field. The plurality of second parameters comprises a camera product code, number of collimators, minimum and maximum object distance, minimum and maximum modulation transfer function used by the automation processing module. Furthermore, the method includes receiving, by the automation processing module, a camera product code as an input from a user. Furthermore, the method includes reading, by the automation processing module, the file relevant to the camera product code and selecting the predefined number of collimators. Furthermore, the method includes loading, by the automation processing module, a plurality of optical parameters from the file and initiating a test process, wherein the test process is performed to determine a qualification of the depth of focus of the camera. Furthermore, the method includes recording, by the automation processing module, one or more measured values from the camera by the plurality of collimators. Furthermore, the method includes comparing, by the automation processing module, the recorded values with a plurality of corresponding predefined values from the file. Furthermore, the method includes automatically deciding, by the automation processing module, the acceptance and non-acceptance of the camera product code based on the comparison of the recorded values with the predefined values from the file.

In accordance with one embodiment of the disclosure a non-transitory computer-readable medium storing a computer program that, when executed by a processor, causes the processor to perform a method measuring depth of field for a camera. The method includes positioning, a camera beneath collimators arrangement in order to capture the images projected by the collimators arrangement. The collimators arrangement is fixed, and configured such that simulating the images are of a minimum focus length and a maximum focus length. The camera is adapted to check image sharpness using a modulation transfer function. Further, the method includes focusing, the camera from minimum to maximum if the modulation transfer function is within a predefined focus range. Furthermore, the method includes measuring, by an image sharpness measurement module, sharpness of the target image. Furthermore, the method includes measuring, by a lens parameter measurement module, a plurality of lens parameters. Furthermore, the method includes automatically measuring, by a plurality of first parameters of an automation processing module, the depth of field. Furthermore, the method includes automatically measuring, by a plurality of first parameters of the automation processing module, measure the depth of field. The plurality of second parameters comprises a camera product code, number of collimators, minimum and maximum object distance, minimum and maximum modulation transfer function used by the automation processing module. Furthermore, the method includes receiving, by the automation processing module, a camera product code as an input from a user. Furthermore, the method includes reading, by the automation processing module, the file relevant to the camera product code and selecting the predefined number of collimators. Furthermore, the method includes loading, by the automation processing module, a plurality of optical parameters from the file and initiating a test process, wherein the test process is performed to determine a qualification of the depth of focus of the camera. Furthermore, the method includes recording, by the automation processing module, one or more measured values from the camera by the plurality of collimators. Furthermore, the method includes comparing, by the automation processing module, the recorded values with a plurality of corresponding predefined values from the file. Furthermore, the method includes automatically deciding, by the automation processing module, the acceptance and non-acceptance of the camera product code based on the comparison of the recorded values with the predefined values from the file. To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system for measuring depth of field for a camera in accordance with an embodiment of the present disclosure;

FIG. 2 is a schematic representation of an exemplary embodiment of the system for measuring depth of field for a camera of FIG. 1 in accordance with an embodiment of the present disclosure;

FIG. 3 is a schematic representation of arrangement of a collimators arrangement and camera of FIG. 1 in accordance with an embodiment of the present disclosure;

FIG. 4 is a schematic representation of a display chart showing output of five collimators arrangement of FIG. 1 in accordance with an embodiment of the present disclosure;

FIG. 5 is a block diagram of a computer or a server for a system for measuring depth of field in accordance with an embodiment of the present disclosure;

FIG. 6a is a flow chart representing steps involved in a method for measuring depth of field for a camera in accordance with an embodiment of the present disclosure; and

FIG. 6b illustrates continued steps involved in the method for measuring depth of field for a camera of FIG. 6a in accordance with an embodiment of the present disclosure.

Further, those skilled in the art will appreciate that elements in the figures are illustrated for simplicity and may not have necessarily been drawn to scale. Furthermore, in terms of the construction of the system, one or more components of the system may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for measuring depth of field for a camera is provided. The system includes a housing, an image sharpness measurement module, a lens parameter measurement module, and a processing subsystem. The housing includes a collimators arrangement and a camera for which the depth of field is to be measured. The collimators arrangement is fixed, and configured such that simulating the images are of a minimum focus length and a maximum focus length. The camera is arranged beneath collimators arrangement and the camera is adapted to check image sharpness using a modulation transfer function. The camera focused from minimum to maximum if the modulation transfer function is within a predefined focus range. The image sharpness measurement module operatively connected with the housing wherein the image sharpness measurement module is adapted to measure sharpness of the target image. The lens parameter measurement module is operatively connected with the housing wherein the lens parameter measurement module is adapted to measure a plurality of lens parameters. The automation processing module is operatively coupled with the lens parameter measurement module. The processing subsystem hosted on a server, configured to execute over a network to control a bidirectional flow among the housing, the image sharpness measurement module, the lens parameter measurement module, and an automation processing module. The automation processing module receives a file. The file includes a plurality of first parameters used in the automation processing module to automatically measure the depth of field. The file also includes a plurality of second parameters. The plurality of second parameters includes a camera product code, number of collimators, minimum and maximum object distance, minimum and maximum modulation transfer function used by the automation processing module to automatically measure the depth of field. The automation processing module is configured to receive a camera product code as an input from a user. The automation processing module is also configured to read the file relevant to the camera product code and select a predefined number of collimators. Further, the automation processing module is configured to load a plurality of optical parameters from the file and initiate a test process. The test process is performed to determine a qualification of the depth of focus of the camera. Furthermore, the automation processing module is configured to record one or more measured values from the image captured by the camera. Furthermore, the automation processing module is configured to compare the recorded values with a plurality of corresponding predefined values from the file. Furthermore, the automation processing module is configured to automatically decide the acceptance and non-acceptance of the camera product code based on the comparison of the recorded measured values with the predefined values from the file.

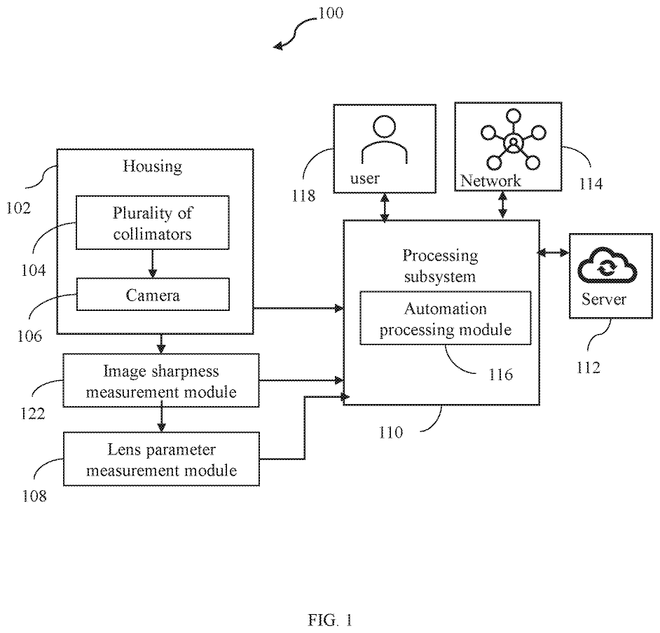

FIG. 1 is a block diagram representing a system 100 for measuring depth of field for a camera in accordance with an embodiment of the present disclosure. The system 100 includes a housing 102, an image sharpness measurement module 122, a lens parameter measurement module 108, and a processing subsystem 110. The housing 102 includes a collimators arrangement 104 and a camera 106. In one embodiment, the housing 102 is configured to capture a plurality of images at different focus length using a single focused camera.

The collimators arrangement 104 is fixed and configured such that simulating the images are of a minimum focus length and a maximum focus length. The minimum focus length (distance) is the closest point at which the lens can focus while maintaining acceptable sharpness, and the maximum focus length (distance) is the furthest point at which the same level of sharpness is maintained. In one embodiment, the configuration of the plurality of collimators 104 is influenced by a precision required by an application of use, wherein the quantity of collimators, arrangement of collimators, the distances set within the collimators are determined in accordance with a requirement of a predefined application. In one embodiment, the predefined applications are material handling processes such as automated assembly, packaging, part transfer, and machine tending.

It will be appreciated to those skilled in the art that the setup of the collimators arrangement 104 may be replaced with any other suitable material that is arranged similar to the said set up from difference working distance. Further, the said setup may vary is shape.

The camera 106 is positioned beneath collimators arrangement in order to capture the images projected by the collimators arrangement 104. Typically, the camera lens is positioned in the camera 106 is adapted to check image sharpness using a Modulation Transfer Function (MTF). In one embodiment, the MTF is a graphical description of the spatial resolution characteristics of an imaging system or its individual components. The camera 106 is focused from minimum to maximum focus length if the modulation transfer function is within a predefined focus range. In one embodiment, standard focal lengths range from 35 mm to 50 mm depending on the type of camera sensor.

The image sharpness measurement module 122 is operatively connected with the housing 102. The image sharpness measurement module 122 is adapted to measure sharpness of the target image.

Further, the lens parameter measurement module 108 is operatively connected with the housing 102 wherein the lens parameter measurement module 108 is adapted to measure a plurality of lens parameters 102. In one embodiment, the plurality of lens parameters includes at least one of a working distance and an image distortion. The image distortion is performed when the lines of an image are straight.

The processing subsystem 110 is hosted on a server 112, configured to execute over a network 114 to control a bidirectional flow among the housing 102, the lens parameter measurement module 108, and an automation processing module 116. In one embodiment, the network 114 may include a wired network such as a local area network (LAN). In another embodiment, the network may include a wireless network such as Wi-Fi, Bluetooth, Zigbee, near-field communication (NFC), infrared communication (RFID), or the like.

The automation processing module 116 includes a plurality of first parameters used in the automation processing module 116 to automatically measure the depth of field. The plurality of first parameters includes a camera product code, number of collimators, minimum and maximum object distance, minimum and maximum modulation transfer function used by the automation processing module 116 to automatically measure the depth of field.

The automation processing module 116 is configured to receive a camera product code as an input from a user 118. In one embodiment, the camera product code may be a unique identifier, assigned to each manufactured camera product which is ready, to be marketed or for sale. The automation processing module 116 is also configured to read the file relevant to the camera product code and select a predefined number of collimators. In one embodiment, the number of collimators is selected based on the requirement of the application. Further, the automation processing module 116 is configured to load a plurality of optical parameters from the file and initiate a test process. The test process is performed to determine a qualification of the depth of focus of the camera 106. Furthermore, the automation processing module 116 is configured to record one or more measured values from camera lens by the collimators arrangement 104. The camera lens is positioned in the camera 106. Furthermore, the automation processing module 116 is configured to compare the recorded values with a plurality of corresponding predefined values from the file. Moreover, the automation processing module 116 is configured to automatically decide the acceptance and non-acceptance of the camera product code based on the comparison of the recorded values from with the predefined values from the file. In one embodiment, the file is an extensible markup language file.

In one embodiment, to measure the depth of field for a camera includes using multiple collimators to measure depth of field for a camera 106. The collimators are fixed at the minimum and maximum focus distances for example: a first collimator at a minimum focus distance and a second collimator at a maximum distance. Images at different focus distances are obtained. The image sharpness using MTF is checked. The MTF focus range is determined. If MTF is within the predefined focus range, then camera 106 is set to be focused on minimum to maximum range. For different focus distance the above process is repeated and the camera DOF is obtained.

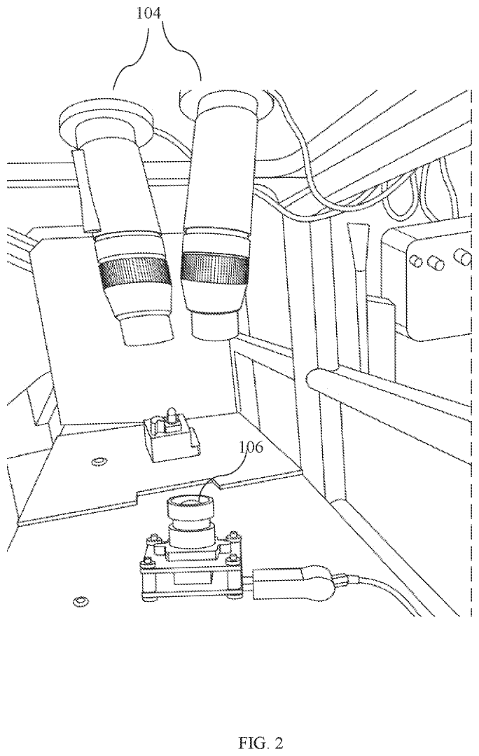

FIG. 2 is a schematic representation of an exemplary embodiment of system 100 for measuring depth of field for a camera using a collimator of FIG. 1 in accordance with an embodiment of the present disclosure. The configuration of collimators 104 is influenced by the predefined precision of the application. The quantity of collimators, their positions, the distances set within the collimators are determined by the specific applications' requirements.

In one embodiment, a camera 106 manufacturing process has many assembly processes including a calibration and a testing. The testing process includes a qualification of the Depth of Focus (DOF) of the camera 106. The system 100 is adapted to test, measure, and qualify the DOF of the camera 106 for the various applications. The manufacturing requirement calls for the production of cameras in volumes for each of the applications.

The DOF requirements of each application is defined in a set of parameters coded in an ‘xml’ file. A collimators arrangement (the number of collimators depends on the application and where the product is deployed), fixed in the field of view of the product to be tested. Each collimator is loaded with a corresponding distance parameter from the ‘xml’ file. If there are two focus points that are to be tested as per the xml parameter, then two collimators are to be selected for the test process with the predefined distance parameters. The first collimator projects the target image at a simulated minimum distance as defined in the parameter file. The second collimator projects the target image simulating the maximum distance. Likewise, it is to be noted that based on the application requirements the number of collimators will be selected accordingly.

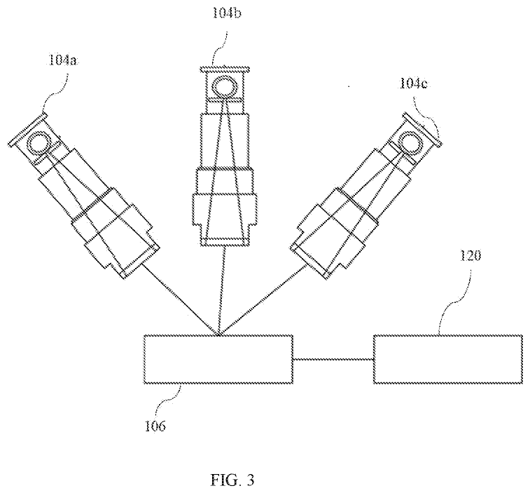

FIG. 3 is a schematic representation of arrangement of the collimators arrangement 104 and the camera 106 of FIG. 1 in accordance with an embodiment of the present disclosure. For example, the system 100 used to measure the depth of field for the camera 106 employs a collimators arrangement 104a, 104b and 104c. In this case, a range of distances between 1 to 4 meters is established for the placement of the collimators arrangement 104a, 104b and 104c. To be more specific, depending upon the application being addressed, the distances may vary, spanning from as short as 0.5 meters to as far as 4 meters. In other words, collimator 104a may be at distance 0.5 m, collimator 104b may be at distance 2 m and collimator 104c may be at distance 4 m. This flexibility in positioning allows for optimal performance and adaptability based on the specific context in which these collimators are being employed. The captured image is checked for sharpness using MTF. If the MTF is at predefined focus range, then camera 106 is set to be focused on minimum to maximum range. In one embodiment, the angle of arrangement of the collimators is guided by an intended projection onto a target surface. In one embodiment, the collimator assembling distances are adjusted and simulated for different distances for verification of passing of the depth of field.

In one embodiment, the minimum focus distance is the closest point at which the lens can focus while maintaining acceptable sharpness, and the maximum focus distance is the furthest point at which the same level of sharpness is maintained. The range between these two points constitutes the depth of field. The determination of acceptable values for the Modulation Transfer Function (MTF) is crucial, as it signifies the lens's capacity to provide focus. In a camera 106, a range of MTF values is established, ensuring that the image achieves a satisfactory level of focus for effective target recognition. In one embodiment, the choice of placement angle of the collimators is guided by the intended projection onto the target surface where the image needs to be displayed on a display chart 120 based on the distortion curve of the lens.

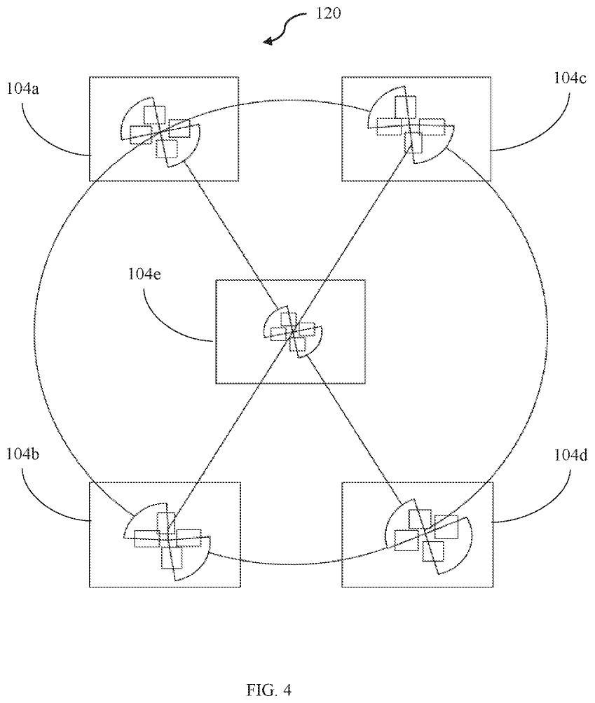

FIG. 4 is a schematic representation of the display chart 120 showing output of five collimators arrangement of FIG. 1 in accordance with an embodiment of the present disclosure. In an exemplary embodiment, 5 collimators 104a, 104b, 104c, 104d, and 104e are arranged to measure the depth of field. In another embodiment, a physical set-up is used to measure the depth of field. Spatial frequency response (SFR) chart 120 may be placed physically, for instance 500 cm. For this set-up any desired material, may be chosen and arranged as collimator fixture set-up and then the depth of field is measured. In one embodiment, L shaped, or other shapes may be selected, and the setup is positioned at 100 cm, 200 cm or other distances and plurality of charts at different distance are visualized. The captured image is checked for sharpness using MTF. If MTF is at predefined focus range, then camera 106 is set to be focused on minimum to maximum range. In one embodiment, the minimum and maximum distances are 0.337 cm, 0.315 cm, 0.288 cm, 0.265 cm, 0.758, and the like. After taking the distances the calculated average may be 0.393 cm.

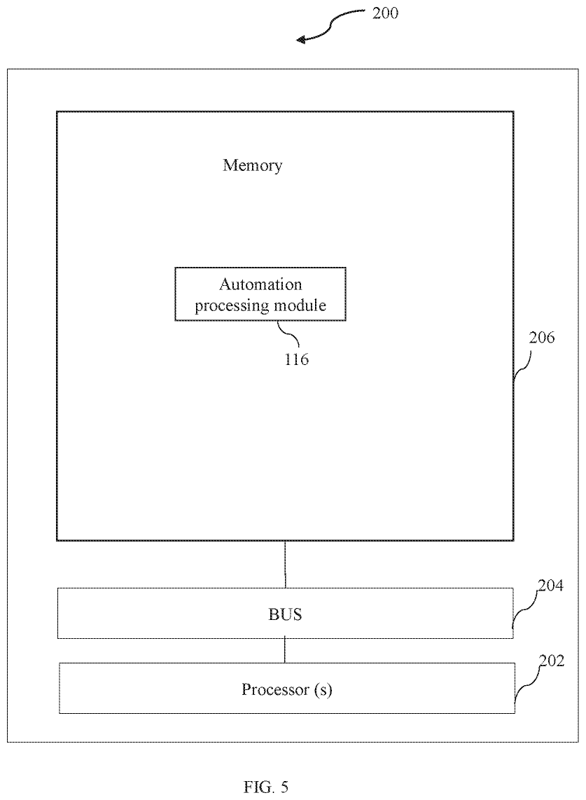

FIG. 5 is a block diagram of a computer or a server for a system for measuring depth of field for a camera in accordance with an embodiment of the present disclosure. The server includes a processor(s) 202, and memory 206 operatively coupled to the bus 204.

The processor(s) 202, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus 204 as used herein refers to be internal memory channels or computer network that is used to connect computer components and transfer data between them. The bus 204 includes a serial bus or a parallel bus, wherein the serial bus transmits data in a bit-serial format and the parallel bus transmits data across multiple wires. The bus 204 as used herein, may include but not limited to, a system bus, an internal bus, an external bus, an expansion bus, a frontside bus, a backside bus, and the like.

The memory 206 includes a plurality of subsystems and a plurality of modules stored in the form of an executable program which instructs the processor to the system illustrated in FIG. 1. The memory 206 is substantially similar for providing the system for measuring depth of field of FIG. 1. The memory 206 has submodule: an automation processing module 116.

The automation processing module 116 includes plurality of first parameters used in the automation processing module 116 to automatically measure the depth of field. The plurality of second parameters includes a camera product code, number of collimators, minimum and maximum object distance, minimum and maximum modulation transfer function used by the automation processing module 116 to automatically measure the depth of field.

The automation processing module 116 is configured to receive a camera product code as an input from a user 118. The automation processing module 116 is also configured to read the file relevant to the camera product code and select the predefined number of collimators. Further, the automation processing module 116 is configured to load a plurality of optical parameters from the file and initiate a test process. The test process is performed to determine a qualification of the depth of focus of the camera 106. Furthermore, the automation processing module 116 is configured to record one or more measured values from a camera lens by the collimators arrangement 104. The camera lens is positioned in the camera. Furthermore, the automation processing module 116 is configured to compare the recorded values with a plurality of corresponding predefined values from the file. Furthermore, the automation processing module 116 is configured to automatically decide the acceptance and non-acceptance of the camera product code based on the comparison of the recorded values with the predefined values from the file.

While computer-readable medium is shown in an example embodiment to be a single medium, the term “computer-readable medium” should be taken to include a single medium or multiple media (for example, a centralized or distributed database, or associated caches and servers) able to store the instructions. The term “computer readable medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

Computer memory elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. An executable program stored on any of the above-mentioned storage media may be executable by the processor(s) 202.

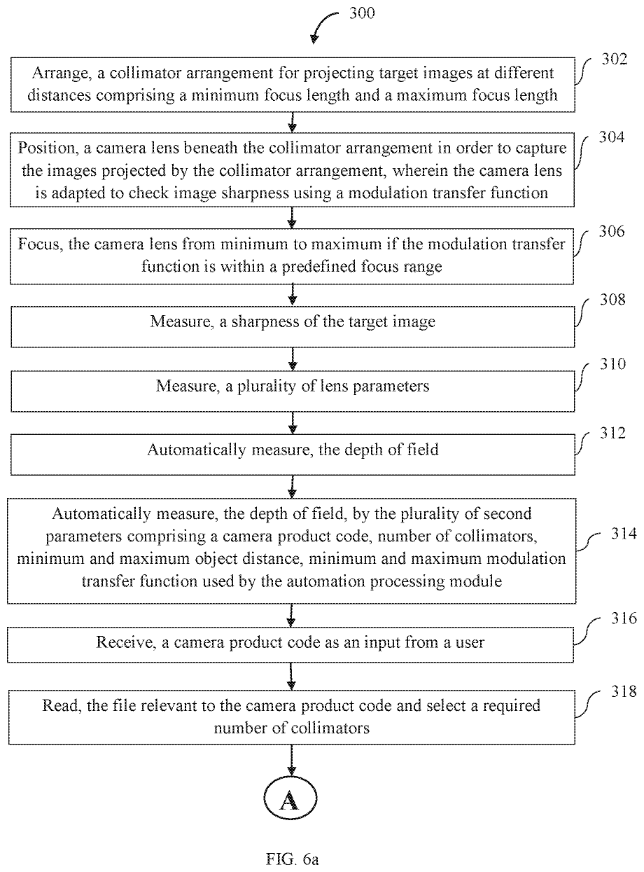

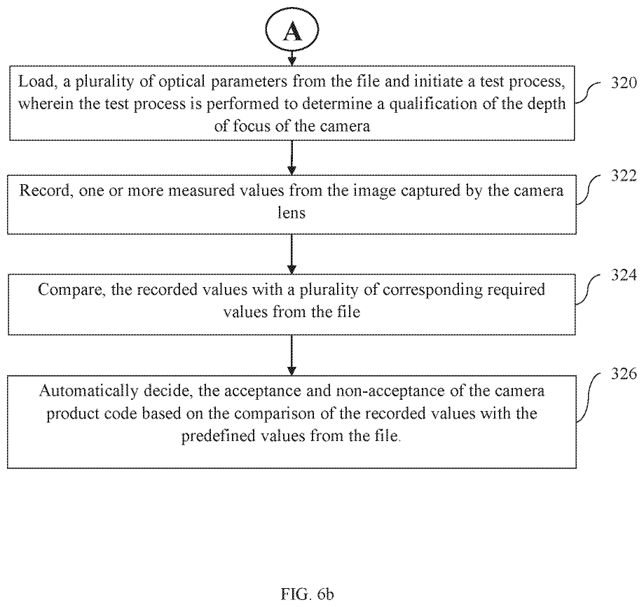

FIG. 6a is a flow chart representing steps involved in the method 300 for measuring depth of field for a camera using a collimator in accordance with an embodiment of the present disclosure and FIG. 6b illustrates continued steps involved in the method for measuring depth of field for a camera of FIG. 6a in accordance with an embodiment of the present disclosure. The method includes loading the plurality of optical parameters required and initiating the process of measuring the depth of field.

The method 300 includes arranging, a collimators arrangement in a housing is fixed and configured such that simulating the images are of a minimum focus length and a maximum focus length in step 302. The method also includes calculating the modulation transfer function value from the image projected by the all the collimators. The method also includes selecting, the number of collimators required for the product.

The method 300 also includes positioning, a camera beneath collimators arrangement, wherein the camera lens is adapted to check image sharpness using a modulation transfer function in step 304.

Further, the method 300 includes focusing, the camera lens from minimum to maximum if the modulation transfer function is within a predefined focus range in step 306. The method also includes capturing, a plurality of images by a selected focused camera. The method also includes calculating modulation transfer function values to assess the image quality. The method also includes checking, image sharpness values using modulation transfer function.

Furthermore, the method 300 includes measuring, by an image sharpness measurement module, sharpness of the target image in step 308.

Furthermore, the method in step 300 includes measuring, by a lens parameter measurement module, a plurality of lens parameters in step 310. The method also includes accepting the product code by a system and reading the file relevant to product code.

Furthermore, the method 300 includes automatically measuring, by a plurality of first parameters of an automation processing module, the depth of field in step 312.

Furthermore, the method 300 includes automatically measuring, by a plurality of first parameters of the automation processing module, measure the depth of field in step 314. The plurality of second parameters comprises a camera product code, number of collimators, minimum and maximum object distance, minimum and maximum modulation transfer function used by the automation processing module.

Furthermore, the method 300 includes receiving, by the automation processing module, a camera product code as an input from a user in step 316.

Furthermore, the method 300 includes reading, by the automation processing module, the file relevant to the camera product code and select a predefined number of collimators 318.

Furthermore, the method 300 includes loading, by the automation processing module, a plurality of optical parameters from the file and initiate a test process in step 320. The test process is performed to determine a qualification of the depth of focus of the camera.

Furthermore, the method 300 includes recording, by the automation processing module, one or more measured values from the camera lens by the collimators arrangement in step 322. The camera lens is positioned in the camera.

Furthermore, the method 300 includes comparing, by the automation processing module, the recorded values with a plurality of corresponding predefined values from the file in step 324.

Furthermore, the method in step 300 includes automatically deciding, by the automation processing module, the acceptance and non-acceptance of the camera product code based on the comparison of the recorded values with the predefined values from the file in step 326.

Various embodiments of the present disclosure provide a system for accurately calculating depth of field. The system disclosed in the present disclosure provides the housing with the collimator set up ensuring the camera lenses to meet the desired performance specifications before being released to the market, thereby providing customers with high-quality imaging products. The collimator set up may also be used to measure other lens parameters such as focal length, image distortion. By using this collimator set up, camera manufacturers can ensure that their lenses meet the desired performance specifications before releasing to the market. The system disclosed in the present disclosure measures the depth of field automatically by using the automation processing module.

Further, the system and method disclosed in the present disclosure describes the automated efficient system for the measurement of DOF for the camera in a high-volume manufacturing process.

For every application the optical parameters including FOV and DOF of the camera and the lens depends on the application. While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for measuring depth of field for a camera comprising:
a housing comprising:
a collimators arrangement is fixed, and configured to simulate the images, wherein the stimulated images are of a minimum focus length and a maximum focus length; and
a camera is positioned beneath the collimators arrangement in order to capture the images projected by the collimators arrangement, wherein the camera lens is adapted to check image sharpness of the target using a modulation transfer function,
wherein the camera lens is focused from minimum to maximum distance range if the modulation transfer function is within a predefined focus range;
an image sharpness measurement module operatively connected with the housing wherein the image sharpness measurement module is adapted to measure sharpness of the target image;
a lens parameter measurement module operatively connected with the housing wherein the lens parameter measurement module is adapted to measure a plurality of lens parameters;
a hardware processor; and
a memory coupled to the hardware processor, wherein the memory comprises a set of program instructions in the form of a processing subsystem, configured to be executed by the hardware processor, wherein the processing subsystem hosted on a server and configured to execute on a network to control bidirectional communications among the housing, the image sharpness measurement module, the lens parameter measurement module, and an automation processing module, wherein the automation processing module is configured to:
receive an input file from a user wherein the file comprises a plurality of first parameters to automatically measure the depth of field, a plurality of second parameters and a camera product code,
wherein the plurality of first parameters comprise a camera product code, number of collimators, minimum and maximum object distance, minimum and maximum modulation transfer function, and automatically measure the depth of field;
read the file corresponding to the camera product code and select a required number of collimators;
load a plurality of optical parameters from the file and initiate a test process, wherein the test process is performed to determine a qualification of the depth of focus of the camera;
record one or more measured values from the image captured by the camera lens;
compare the recorded values with a plurality of corresponding predefined values from the file; and
automatically decide the acceptance and non-acceptance of the camera product code, based on the comparison of the recorded measured values with the predefined values from the file.

2. The system of claim 1, wherein the housing is configured to capture a plurality of images at different working distances using the camera, wherein the camera is single focused.

3. The system of claim 1, wherein a configuration of the collimators arrangement is influenced by a precision required by an application of use, wherein the quantity of collimators, arrangement of collimators, the distances set within the collimators is determined in accordance with a requirement of a predefined application.

4. The system of claim 1, wherein the angle of arrangement of the collimators is guided by an intended projection onto a target surface.

5. The system of claim 1, wherein the file is an extensible markup language file.

6. The system of claim 1, wherein the collimator assembling distance is adjusted and simulated for different distances for verification of passing of the depth of field.

7. A method for measuring depth of field for a camera comprising:
arranging, a collimators arrangement in a housing, wherein the collimators arrangement is fixed, and configured to simulate the images with a minimum focus length and a maximum focus length;
positioning, a camera beneath collimators arrangement in order to capture the images projected by the collimators arrangement, wherein the camera is adapted to check image sharpness using a modulation transfer function;
focusing, the camera from minimum to maximum if the modulation transfer function is within a predefined focus range;
measuring, by an image sharpness measurement module, sharpness of the target image;
measuring, by a lens parameter measurement module, a plurality of lens parameters;
automatically measuring, by a plurality of first parameters of an automation processing module, the depth of field;
automatically measuring, by a plurality of first parameters of the automation processing module, the depth of field, wherein the plurality of second parameters comprises a camera product code, number of collimators, minimum and maximum object distance, minimum and maximum modulation transfer function used by the automation processing module;
receiving, by the automation processing module of a processing subsystem, a camera product code as an input from a user;
reading, by the automation processing module of the processing subsystem, the file relevant to the camera product code and select a required number of collimators;
loading, by the automation processing module of the processing subsystem, a plurality of optical parameters from the file and initiate a test process, wherein the test process is performed to determine a qualification of the depth of focus of the camera;
recording, by the automation processing module, one or more measured values from the camera by the plurality of collimators;
comparing, by the automation processing module, the recorded values with a plurality of corresponding required values from the file; and
automatically deciding, by the automation processing module of the processing subsystem, the acceptance and non-acceptance of the camera product code based on the comparison of the recorded values with the predefined values from the file.

8. The method of claim 7, further comprises accepting the product code by a system and reading the file relevant to product code.

9. The method of claim 7, further comprises calculating the modulation transfer function value from the image projected by the all the collimators.

10. The method of claim 7, further comprises capturing, a plurality of images by a selected focused camera.

11. The method of claim 7, further comprises selecting, the number of collimators required for the product.

12. The method of claim 7, further comprises calculating modulation transfer function values to assess the image quality.

13. The method of claim 7, further comprises loading the plurality of optical parameters required and initiating the process of measuring the depth of field.

14. The method as claimed in claim 7, further comprises checking, image sharpness values using modulation transfer function.

15. A non-transitory computer-readable medium storing a computer program that, when executed by a processor, causes the processor to perform a method measuring depth of field for a camera, wherein the method comprises:
arranging, a collimators arrangement in a housing for projecting target images at different distances comprising a minimum focus length and a maximum focus length;
positioning, a camera beneath collimators arrangement in order to capture the images projected by the collimators arrangement, wherein the camera is adapted to check image sharpness using a modulation transfer function;
focusing, the camera from minimum to maximum if the modulation transfer function is within a predefined focus range;
measuring, by an image sharpness measurement module, sharpness of the target image;
measuring, by a lens parameter measurement module, a plurality of lens parameters;
automatically measuring, by a plurality of first parameters of an automation processing module, the depth of field;
automatically measuring, by a plurality of first parameters of the automation processing module, measure the depth of field, wherein the plurality of second parameters comprises a camera product code, number of collimators, minimum and maximum object distance, minimum and maximum modulation transfer function used by the automation processing module;
receiving, by the automation processing module, a camera product code as an input from a user;
reading, by the automation processing module, the file relevant to the camera product code and select a required number of collimators;
loading, by the automation processing module, a plurality of optical parameters from the file and initiate a test process, wherein the test process is performed to determine a qualification of the depth of focus of the camera;
recording, by the automation processing module, one or more measured values from the camera by the plurality of collimators;
comparing, by the automation processing module, the recorded values with a plurality of corresponding predefined values from the file; and
automatically deciding, by the automation processing module, the acceptance and non-acceptance of the camera product code based on the comparison of the recorded values with the predefined values from the file.
